(19) United States
(12) Patent Application Publication
(10) Pub. No.: US 2006/0228525 A1
(43) Pub. Date: Oct. 12, 2006

(54) Method and apparatus for producing an article for displaying an image

(76) Inventor: Julian Dakowski, London (GB)

Correspondence Address: PATTERSON & SHERIDAN, L.L.P., 3040 POST OAK BOULEVARD, SUITE 1500, HOUSTON, TX, 77056, US

(21) Appl. No.: 10/567,494

(22) PCT Filed: Aug. 6, 2004
(86) PCT No.: PCT/GB04/03379

§ 371 Date: Feb. 7, 2006

(30) Foreign Application Priority Data
Aug. 7, 2003 (GB) 0318569.1

(51) Int. Cl. B32B 3/00

(52) U.S. Cl. 428/172

(57) ABSTRACT

The present application relates to a process for manufacturing an article (1) comprising a substrate (3) and a translucent, semi-transparent or transparent overlay (5). The substrate (3) has a contoured surface (7) and the overlay (5) is provided over at least a portion of the contoured surface. The process comprises using a computer system to generate data corresponding to a three-dimensional image. The generated data is used to control apparatus to form at least a portion of a mould for defining the contoured surface (7) of the substrate (3) and the mould is then used to form at least the contoured surface of the substrate. The overlay (5) is then provided over at least a portion of the contoured surface (7). The present application also relates to articles (1) formed by this process.

The present application relates to a process for producing an article having an image visible by incident light reflecting off of a three-dimensional contoured surface. The present application also relates to apparatus for producing said articles, and the articles themselves.

It is known to produce pictorial works in the style of émaux ombrants pictorial works by carving an image in wax or clay and then creating a mould to allow substrates to be moulded. A glaze may then be provided over the substrate. However, these techniques are particularly labour intensive and rely heavily on the skill of the craftsman,

It is also known from U.S. Pat. No. 6,287,492 to form a lithophane pictorial work. The resulting work provide a visual 3-dimensional image which is viewed from the front with light passing through the work from the rear. The image is created by varying the thickness of the material from which the work is formed to vary the amount of light which is permitted to pass through it. A portion of the work having a relatively small thickness will allow a large proportion of the light to pass through it and the image will appear relatively light in this area. A portion of the work having a relatively thick section will allow less light to pass through and the image will be relatively dark in this region. However, in order to view the image in a lithophane, light must be allowed to pass through from behind. Thus, the display possibilities for a lithophane are limited.

A method of manufacturing metal, plastic and ceramic panels is known from JP-2002-109314. This method involves converting two-dimensional image data provided by a customer into three-dimensional data and using a numerically controlled machine to engrave the three-dimensional image in the desired object. The resulting design panel is viewed by light reflecting off the machined surface. Although a light source is not required behind the work to allow it to be viewed, the subtleties of the image may be difficult to distinguish.

The inventor has recognised a need for a process and apparatus to allow an article having an image, which may be readily displayed, to be formed.

Viewed from a first aspect, the present invention provides a process for manufacturing an article comprising a substrate and a translucent, transparent or semi-transparent overlay, the substrate having a contoured surface and the overlay being provided over at least a portion of said contoured surface, the process comprising the following steps:

(a) using a computer system to generate data corresponding to a three-dimensional image;

(b) using the generated data to control apparatus to form at least a portion of a mould for defining the contoured surface of the substrate;

(c) using said mould to form at least the contoured surface of the substrate; and

(d) providing the overlay over said at least a portion of the contoured surface.

Providing a translucent, transparent or semi-transparent overlay allows light to be reflected off of the contoured surface of the substrate. The contoured surface generally corresponds to the three-dimensional image. The intensity of the reflected light depends on the thickness of overlay through which it has passed and a grey-scale image may be created by varying the thickness of the overlay. Thus, the contoured surface and the overlay in combination form an image based on the three-dimensional image data.

At least a portion of the outer surface of the overlay is preferably substantially planar. The process preferably includes providing sufficient overlay-forming medium onto the substrate to ensure that any recesses in the contoured surface are filled whilst also covering any peaks defined therein to ensure that a substantially planar outer surface is formed. It may be desirable in certain cases to allow some of the peaks to project above the natural level of the overlay to create highlight effects in the resulting image. The remainder of the outer surface is preferably planar.

Alternatively, the overlay may be formed to create a non-planar outer surface. The outer surface may be concave or convex. The overlay is preferably maintained sufficiently thick such that the profile of the outer surface is substantially unaffected by the profile of the contoured surface (thus, the outer surface may be maintained substantially uniform irrespective of the profile of the underlying contoured surface).

In arrangements where the outer surface of the overlay is non-planar the three-dimensional image data may be manipulated to reflect variations or changes in the profile of the outer surface of the overlay. For example, the height of peaks and troughs to be formed in the contoured surface may be measured relative to a datum surface corresponding to the outer surface of the overlay. Advantageously, this data manipulation may reduce distortion of the resulting image. The outer surface of the overlay may itself have patterns or designs formed therein to enhance the decorative effect of the article. The overlay may be formed by moulding (e.g. injection moulding), pressing or other suitable techniques.

The substrate may be formed from any suitable method, for example by moulding, injection moulding, pressing or embossing.

Viewed from a further aspect, the present invention provides a process for manufacturing an article comprising a substrate and a transparent, translucent, or semi-transparent overlay, the substrate having a contoured surface and the overlay being provided over at least a portion of said contoured surface, the process comprising the following steps:

(a) using a computer system to generate data corresponding to a three-dimensional image;

(b) using the generated data to control apparatus to form he contoured surface; and

(c) providing the overlay over said at least a portion of he contoured surface such that at least a portion of an outer surface of the overlay is substantially planar.

Again, the contoured surface and the overlay in combination form an image based on the three-dimensional image data. The at least a portion of the outer surface is preferably substantially planar irrespective of the profile of the contoured surface.

Although the overlay-forming medium may initially be a gel which is applied to the substrate, it is preferably a liquid which is, for example, poured or squirted onto the substrate. The overlay-forming medium may alternatively be a solid which undergoes a phase change to a liquid. The overlay-forming medium may be applied by pouring, spraying, dipping or screeding. The liquid then preferably undergoes a phase change and becomes a solid. If the overlay-forming medium is initially a solid medium, for example in the form of a powder, it may be converted to a liquid by applying heat. When the overlay-forming medium is a liquid it may advantageously flow over the contoured surface of the substrate.

The process may also include the step of supplying data corresponding to a two dimensional image to the computer system and generating the data corresponding to the three-dimensional image from said two dimensional image data. The two dimensional image-data may correspond to a photographic image or a picture. Data corresponding to a colour photographic image or picture may be supplied to the computer system and the process may further comprise the step of converting the two or three dimensional image data to monochrome greyscale image data.

The process may further comprise the step of coating the contoured surface with a reflective material. This is particularly appropriate if the substrate is made of a translucent, transparent or semi-transparent material. However, the substrate is preferably opaque, or substantially opaque. The substrate is preferably made from a material which provides a reflective surface without the need to apply a reflective coating.

The processes described herein are particularly suited to forming tiles, including decorative tiles of the type suitable for use in showers, bathrooms, kitchens. Decorative tiles for use in signage and plaques, and also commemorative tiles are also envisaged. It is also envisaged that the process could be used to form mugs, plates, cups and other types of crockery.

The substrate may be made of clay, ceramic, glass, metal, resin, china ware (china clay), porcelain or plastic, The overlay may be a glaze, glass, resin, enamel or plastic.

The article may be a bar of soap and at least one of the substrate and the overlay is made of soap. The article may be a foodstuff, such as a lollipop, and at least one of the substrate and the overlay are edible. The contoured surface may, for example, display the brand name of the article and/or promotional details or imagery.

The apparatus may be a computer numerically controlled engraving or milling machine.

It will be appreciated that the generated data could be used to control apparatus to form both the substrate and the overlay.

Viewed from a further aspect, the present application relates to a system to be operated in accordance with the process described herein to produce an article comprising a substrate and a translucent, transparent or semi-transparent overlay, the substrate having a contoured surface and the overlay being provided over said contoured surface.

Viewed from a yet still further aspect the present application relates to a bar of soap comprising a substrate and a translucent or transparent overlay, the substrate having a contoured surface and the overlay being provided over said contoured surface. The contoured surface and the overlay in combination preferably form a three-dimensional image.

Viewed from a still further aspect, the present application relates to a process for manufacturing an article comprising a substrate and a translucent, semi-transparent or transparent member, the member having a contoured surface and the substrate being provided over at least a portion of said contoured surface, the process comprising the following steps;

(a) using a computer system to generate data corresponding to a three-dimensional image;

(b) using the generated data to control apparatus to form at least a portion of a mould for defining the contoured surface of the member;

(c) using said mould to form at least the contoured surface of the member; and

(d) providing the substrate over said at least a portion of the contoured surface.

Thus, the contoured surface is formed in the. translucent, transparent or semitransparent member and the substrate provided over the contoured surface The contoured surface and the substrate in combination form an image based on the three-dimensional image data.

It is not necessary that the back surface of the substrate is planar. The back surface may, for example, be curved or have a pattern formed therein to allow the article readily to be mounted (especially when the article is a tile).

Viewed from a yet still further aspect, the present application relates to a process for manufacturing an article comprising a substrate and a transparent, semi-transparent or translucent member, the member having a contoured inner surface, the substrate being provided over at least a portion of said contoured surface, the process comprising the following steps:

(a) using a computer system to generate data corresponding to a three-dimensional image;

(b) using the generated data to control apparatus to form the contoured surface; and

(c) providing the substrate over said at least a portion of the contoured surface.

Again, the contoured surface and the substrate in combination form an image based on the three-dimensional image data. The member preferably has an outer surface which is substantially planar.

The substrate may be a reflective or mirrored coating.

It will be appreciated that the generated data could be used to control apparatus to form both the substrate and the member having a contoured surface.

The processes described herein may include the step of dividing the generated data into a plurality of subsets and using each subset of data to form a separate article. The articles may then be combined to form a composite image corresponding to the three-dimensional image.

Alternatively, in embodiments whereby data corresponding to a two-dimensional image is supplied, the data corresponding to the image may be divided into segments and each segment of data used to generate data corresponding to the three-dimensional image. Again, the resulting articles may be arranged to form a composite image. These processes allow larger images to be created without increasing the size of each article formed.

The present application also relates to a system to be operated in accordance with the process described herein to produce an article comprising a substrate and a translucent, transparent or semi-transparent member, the member having a contoured surface and the substrate being provided over at least a portion of said contoured surface,

A preferred embodiment of the present invention will now be described by way of example only and with reference to the accompanying drawings, in which:

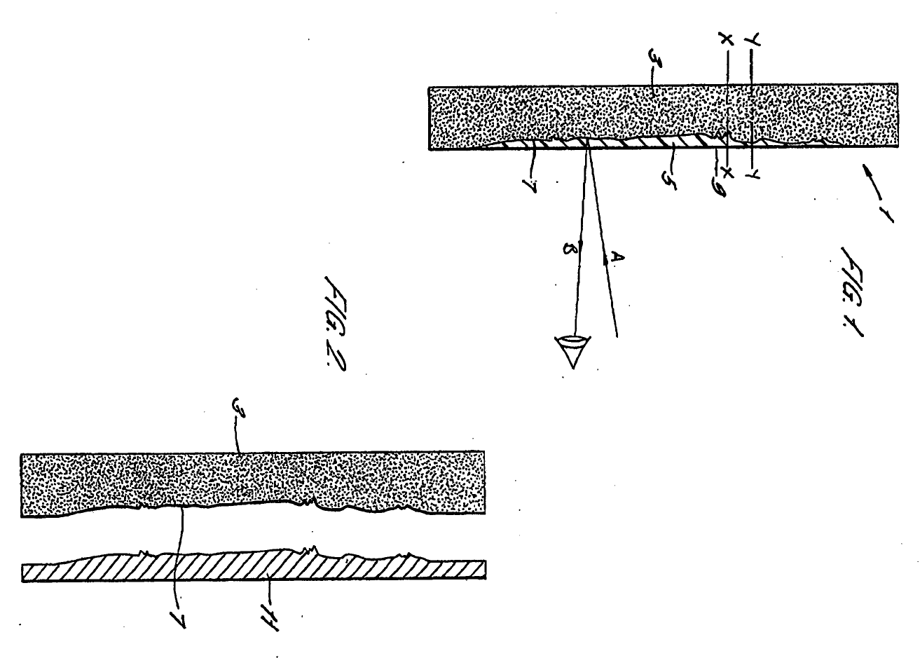

FIG. 1 shows a cross-sectional view through a tile produced in accordance with the present invention;

FIG. 2 shows a cross-sectional view of the mould for forming the article shown in FIG. 1;

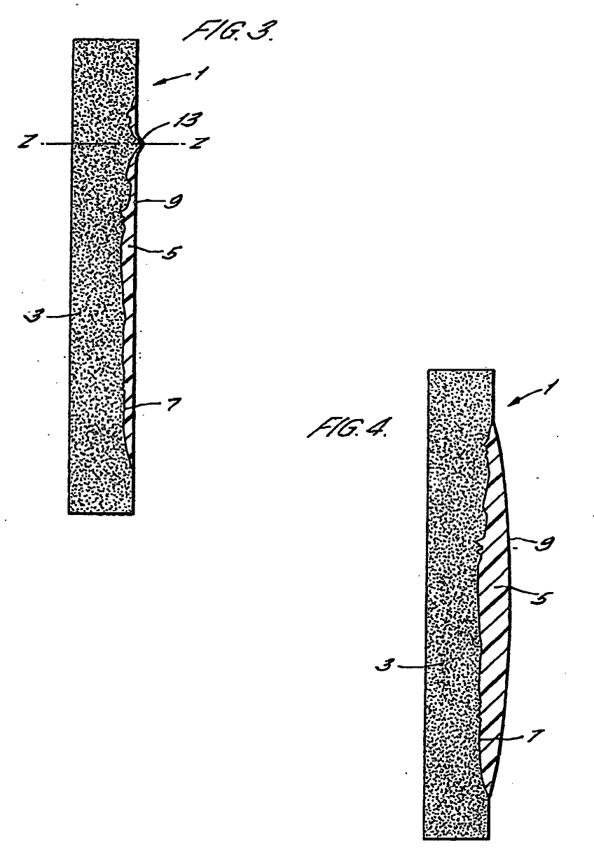

FIG. 3 shows a cross-sectional view through a second embodiment of a tile produced in accordance with the present invention; and

FIG. 4 shows a cross-sectional view through a third embodiment of a tile produced in accordance with the present invention.

A cross-section through a tile 1 produced in accordance with the present invention is shown in FIG. 1. The tile comprises an opaque substrate 3 and a semi-transparent glaze 5. The substrate 3 has a contoured reflective surface 7 which defines a display image in low relief. The display image may be a picture of a famous person, a landscape or any other decorative image. The glaze 5 has a substantially planar outer surface 9.

The display image is defined by the intensity of the light reflected off the contoured surface 7 and this is dependent on the thickness of the glaze 5 through which the light must travel. That is to say, the intensity of the reflected light is varied by density related obscuration within the glaze S. By varying the depth of the contours of the surface 7 relative to the outer surface 9 of the glaze 5, a greyscale image may be created. In FIG. 1, the incident light is labelled with an arrow A and the reflected light with an arrow B. By way of example, the intensity of the reflected light at a first section XX and a second section YY of the article shown in FIG. 1 will now be considered.

The glaze 5 in the section YY is relatively thin and, therefore, light reflecting off of the contoured surface 7 passes through a relatively small amount of glaze; thus, the light intensity is relatively high and the image appears relatively light in this area. The glaze 5 is thicker in the section XX and therefore the reflected light must travel through a greater amount of glaze 5; thus, the reflected light is less intense and the image appears relatively dark in this area.

The desired display image can therefore be created by varying the depth of the contours in the surface 7. The peaks in the contoured surface 7 (such as at section YY) appear lightest in the display image and the troughs (such as at section XX) appear darkest.

The image is generally recognisable from the substrate 3 alone. However, only in the final glazed state can the image be properly appreciated by virtue of the variations in the intensity of the light reflected from the contoured surface 7 through the glaze 5. Thus, the image is defined by the interaction of the contoured surface 7 of the substrate 3 and the glaze 5. The resulting image can be a photographic quality picture or pictorial image.

A method of producing the display tile 1 in accordance with the present invention will now be described.

The image to be displayed is initially a two-dimensional image, such as a photograph or picture. A suitable photograph may be taken directly from life or other graphical representations. The two-dimensional image is then supplied to a computer system, for example by scanning the picture or image, or supplying it directly from a digital camera.

Once the two-dimensional image has been supplied to the computer it is converted to a monochrome greyscale image. Software, such as the “ArtCAM Pro” package available from Delcam plc, Small Reath Business Park, Birmingham, the United Kingdom, then converts the monochrome two-dimensional image into a three-dimensional low relief data file. The three-dimensional low relief contour is thereby an interpretation of the two-dimensional image of origin wherein a height from a reference plane to peaks relate to the greyscale intensities of the image of origin. The three-dimensional image may be viewed on screen and modifications made to the image at this stage.

The three-dimensional image data file is then used to produce a tooling data file for a computer numerically controlled (CNC) engraving machine to create a mould 11 for forming the tile 1. The CNC engraver then produces the mould 11 in a suitable material. The mould 11 is effectively a mirror image of the tile to produce the desired contours in the surface 7 (if the image on the tile 1 is considered to be a “positive” image, then the mould will be a “negative” image). Thus, a trough in the contoured surface 7 of the substrate 3 will be defined by a peak in the mould 11 and vice versa.

The mould is then pressed into clay to emboss the image in the mould onto the clay and thereby to form the contoured surface 7. The clay is then fired so as to form the substrate 3 of the tile 1.

The next step is to provide the semitransparent glaze 5 on the surface of the clay substrate 3. The glaze-forming medium is initially a powder which is provided on the surface of the substrate 3. The substrate 3 and the powder are then fired together to cause the powder to return to a glassy state which flows over the surface of the substrate 3. Sufficient glaze-forming medium is provided to ensure that the glaze 5 fills the contours in the surface 7 and forms a uniform outer surface 9. A wall (not shown) may be formed in the substrate 3 around the contoured surface 7 to help retain the glaze 5 in the desired position when it is in a liquid state.

A variable thickness of glaze 5 is created as it follows and adheres to the contoured surface 7 of the substrate 3. Thus, the inner surface of the glaze 5 is contoured and substantially matches the contoured surface 7 of the substrate 3, and the outer surface 9 of the glaze 5 is substantially planar.

It will be appreciated that the process described herein may be employed to create display tiles and other articles from three-dimensional data generated in the computer, for example, using conventional computer Aided Design (CAD) software. It is not essential that the image is initially a two-dimensional image, such as a photograph, although this is preferred.

A second embodiment of a tile 1 produced in accordance with the present invention is shown in FIG. 3. The tile 1 according to the second embodiment is generally the same as the tile according to the first embodiment and like reference numerals have been used for like components.

The tile 1 is produced using the same process as employed to produce the tile according to the first embodiment. However, in this embodiment, a portion of the contoured surface 7 (shown at section ZZ) projects above the natural level of the outer surface 9 of the glaze 5 when it flows over the substrate 3. Thus, a peak 13 is formed which projects above the generally planar outer surface 9 of the glaze 5. The glaze 5 covers the peak 13 but is much thinner as it tends to flow off the peak when it is in a liquid state. The image formed by the combination of the contoured surface 7 and the glaze 5 therefore appears much lighter in the region of the peak 13 than in other areas where the glaze is thicker. The peak 13 therefore creates a highlight in the resulting image.

It will be appreciated that in this embodiment the outer surface 7 is not planar over its entire surface as the peak 13 extends above the natural level of the glaze 5. The remainder of the outer surface 7 of the glaze 5 is planar.

A third embodiment of a tile 1 produced in accordance with the present invention is shown in FIG. 4. Again, the tile 1 is generally the same as those described above and like reference numerals have been used for like components.

The overlay 5 in this embodiment is made of a semi-transparent plastics material, rather than a glaze, and has a generally convex outer surface 9. The production of the tile 1 according to this third embodiment will now be described.

The substrate 3, having a contoured surface 7, is formed using the same techniques as described herein for the first embodiment. The substrate 3 is then located in a mould cavity having a concave inner surface for defining the outer surface 9 of the overlay. The plastics material to form the overlay 5 is then injected into the mould cavity in a molten state in accordance with known injection moulding techniques. The plastics material then sets and forms the semi-transparent overlay 5. The tile 1 is then removed from the mould cavity.

An image is created in the resulting tile 1 by the combination of the contoured surface of substrate 3 and the overlay 5 in the same way as described herein for the first and second embodiments. However, because of the curved profile of the outer surface 9 of the overlay 5S the thickness of the overlay itself varies over the surface of the tile 1 regardless of the profile of the contoured surface 7. In view of this variation, it is desirable to curve the contoured surface 7 of the substrate 3 to correspond to the curvature of the outer surface 9 of the overlay 5. The height of the peaks and troughs in the contoured surface 7 may be measured relative to a non-planar datum surface corresponding to the outer surface 9 of the overlay 5 (rather than a planar datum surface as may be employed to produce the tiles 1 according to the first and second embodiments of the present invention). Profiling the contoured surface 7 to match the outer surface 9 can be implemented by manipulating the data used to form the contoured surface 7. This manipulation may be performed by the computer system at the same time as the data corresponding to a three-dimensional image is generated. The profiling of the contoured surface 7 to correspond to the outer surface 9 may advantageously reduce distortion of the resulting image.

The process according to the third embodiment may be modified such that the semi-transparent overlay 5 is formed with a contoured inner surface, for example by injection moulding. The overlay 5 may then be located in a mould cavity and the substrate 3 formed by injecting molten plastics material into the mould cavity.

It will be appreciated that the processes described herein for forming the tile according to the third embodiment of the present invention are also suitable for forming other articles. For example, the process could be used to form bars of soap wherein the substrate is an opaque material and the overlay is a semi-transparent material. Equally, the process could be-used to form food products. It is not necessary that the substrate has a planar back surface.

The outer surface 9 of the overlay 5 may have a design embossed into it for further decorative effect. Again, the three-dimensional data to define the contoured surface 7 may be manipulated to reduce distortion of the image formed by the combination of the contoured surface 7 and the overlay 5.

The substrate in the embodiments described herein is moulded in a mould and the mould may be produced by any suitable method, for example forming, pressing, embossing, engraving, hardening, firing or milling. The glaze 5 or other semi-transparent overlay may be applied to the substrate 3 by pouring, floating, flooding, firing, glazing, enamelling, moulding, polishing, covering, screeding, powder levelling, setting and so on.

It will also be appreciated that the present invention is not limited to applications for producing tiles. Further applications such as enamelling (for example, jewellery, badges, trophies), ceramics (for example, tiles, china, plagues), confectionery and food (for example, cakes, jellies, biscuits, mousse, aspic), resin (for example, in corporate and promotional goods), and cosmetics (for example, in soap to facilitate brand identity and/or promotions) are also envisaged.

In the arrangement outlined above in respect of enamelling, the substrate is typically a metal and the semi-transparent overlay is created by floating or glazing of glass over the metal substrate.

A further application is envisaged whereby obscure or semi-opaque glass is employed. The body of the glass takes on the role of the translucent, transparent or semi-transparent overlay and a mirrored or highly reflective coating is applied to a contoured surface formed in the back surface of the overlay. The coating in this arrangement acts as the substrate.

The present invention may be used to form a plurality of articles having images formed therein which may be arranged to form a single composite image. For example, the present invention may be employed to form nine articles to be arranged in a 3×3 matrix to form a single image. Of course, 2×2, 4×4, 2×3, 3×4 matrices and the like may also be employed. The processes according to the present invention may therefore include a step of dividing an image into a plurality of segments, each segment of the whole image then being applied to a single article.

The process may also allow for strips of the image to be omitted to allow for a space to be left between adjacent articles (the width of the space corresponding to the width of the strip) when they are mounted. This is preferable if the articles are tiles which will typically have a space left for grouting.

1. A process for manufacturing an article comprising a substrate and a an overlay that is at least one of translucent, semi-transparent or transparent, the substrate having a contoured surface and the overlay being provided over at least a portion of said contoured surface, the process comprising the following steps:
(a) using a computer system to generate data corresponding to a three-dimensional image;
(b) using the generated data to control an apparatus to form at least a portion of a mould for defining the contoured surface of the substrate;
(c) using said mould to form at least the contoured surface of the substrate; and
(d) providing the overlay over said at least a portion of the contoured surface.

2. A process as claimed in claim 1, wherein said substrate is formed by at least one of: moulding, pressing or embossing.

3. A process as claimed in claim 1, wherein at least a portion of an outer surface of the overlay is substantially planar.

4. A process for manufacturing an article comprising a substrate and a an overlay that is at least one of translucent, semi-transparent or transparent overlay, the substrate having a contoured surface and the overlay being provided over at least a portion of said contoured surface, the process comprising the following steps:
(a) using a computer system to generate data corresponding to a three-dimensional image;
(b) using the generated data to control an apparatus to form the contoured surface; and
(c) providing the overlay over said at least a portion of the contoured surface such that at least a portion of an outer surface of the overlay is substantially planar.

5. A process as claimed in claim 1, wherein the overlay is initially a liquid medium and the process includes providing the liquid medium on the contoured surface.

6. A process as claimed in claim 1, wherein the overlay is initially a solid medium and the process includes providing the solid medium on the contoured surface and converting it to a liquid.

7. A process as claimed in claim 6, wherein the solid medium is converted to a liquid by applying heat.

8. A process as claimed in claim 1, further comprising the step of supplying data corresponding to a two-dimensional image to the computer system and generating the data corresponding to the three-dimensional image from said two-dimensional image data.

9. A process as claimed in claim 8, wherein the two-dimensional image data corresponds to a photographic image or a picture.

10. A process as claimed in claim 8, wherein the two-dimensional image data supplied to the computer system corresponds to at least one of a colour photographic image or picture and the process further comprises the step of converting at least one of the two-dimensional or three-dimensional image data to monochrome greyscale image data.

11. A process as claimed in claim 1, further comprising the step of coating the contoured surface with a reflective material.

12. A process as claimed in claim 1, wherein the article is a tile.

13. A process as claimed in claim 1, wherein the substrate is made of clay, ceramic, glass, metal, resin or plastic.

14. A process as claimed in claim 1, wherein the overlay is a glaze, glass, resin, enamel or plastic.

15. A process as claimed in claim 1, wherein the article is a bar of soap and at least one of the substrate and the overlay is made of soap.

16. A process as claimed in claim 1, wherein the article is a foodstuff and the substrate and the overlay are edible.

17. A process as claimed in claim 1, wherein said apparatus is a computer numerically controlled engraving or milling machine.

18. (canceled)

19. A bar of soap comprising:
a substrate; and
an overlay that is at least one of translucent, semi-transparent or transparent, the substrate having a contoured surface and the overlay being provided over at least a portion of said contoured surface.

20. A process for manufacturing an article comprising a substrate and a member that is at least one of translucent, semi-transparent or transparent, the member having a contoured surface and the substrate being provided over at least a portion of said contoured surface, the process comprising the following steps:
(a) using a computer system to generate data corresponding to a three-dimensional image;
(b) using the generated data to control an apparatus to form at least a portion of a mould for defining the contoured surface of the member;
(c) using said mould to form at least the contoured surface of the member; and
(d) providing the substrate over said at least a portion of the contoured surface.

21. A process for manufacturing an article comprising a substrate and a member that is at least one of transparent, semi-transparent or translucent, the member having a contoured inner surface, the substrate being provided over at least a portion of said contoured surface, the process comprising the following steps:
(a) using a computer system to generate data corresponding to a three-dimensional image;
(b) using the generated data to control an apparatus to form the contoured surface; and
(c) providing the substrate over said at least a portion of the contoured surface.

22. A process as claimed in claim 20, wherein the substrate is a coating that is at least one of reflective or mirrored.

23-25. (canceled)

26. A process as claimed in claim 4, wherein the overlay is initially a liquid medium and the process includes providing the liquid medium on the contoured surface.

27. A process as claimed in claim 4, wherein the overlay is initially a solid medium and the process includes providing the solid medium on the contoured surface and converting it to a liquid.

28. A process as claimed in claim 4, further comprising the step of supplying data corresponding to a two-dimensional image to the computer system and generating the data corresponding to the three-dimensional image from said two-dimensional image data.

29. A process as claimed in claim 4, further comprising the step of coating the contoured surface with a reflective material.

30. A process as claimed in claim 4, wherein the article is a tile.

31. A process as claimed in claim 4, wherein the article is a bar of soap and at least one of the substrate and the overlay is made of soap.

32. A process as claimed in claim 4, wherein the article is a foodstuff and the substrate and the overlay are edible.

33. A process as claimed in claim 4, wherein said apparatus is a computer numerically controlled engraving or milling machine.

34. A system for manufacturing an article comprising a substrate and an overlay that is at least one of translucent, semi-transparent or transparent, the substrate having a contoured surface and the overlay being provided over at least a portion of said contoured surface, the system comprising:
a computer system for generating data corresponding to a three-dimensional image;
one or more apparatus adapted to form the contoured surface of the substrate based on the generated data, and provide the overlay over said at least a portion of the contoured surface.

35. The system of claim 34, wherein the one or more apparatus is adapted to form the contoured surface of the substrate by:
forming at least a portion of a mould for defining the contoured surface of the substrate; and
using said mould to form at least the contoured surface of the substrate.

36. A system for manufacturing an article comprising a substrate and a member that is at least one of translucent, semi-transparent or transparent, the member having a contoured surface and the overlay being provided over at least a portion of said contoured surface, the system comprising:
a computer system for generating data corresponding to a three-dimensional image;
one or more apparatus adapted to form the contoured surface of the member based on the generated data, and provide the substrate over said at least a portion of the contoured surface of the member.

37. The system of claim 36, wherein the one or more apparatus is adapted to form the contoured surface of the member by:
forming at least a portion of a mould for defining the contoured surface of the member; and
using said mould to form at least the contoured surface of the member.
